(19) United States
(12) Patent Application Publication
(10) Pub. No.: US 2016/0248596 A1
(43) Pub. Date: Aug. 25, 2016

(54) REFLECTING MDNS PACKETS

(71) Applicant: HEWLETT PACKARD ENTERPRISE DEVELOPMENT LP, Houston, TX (US)

(72) Inventors: Joel Beaudet, Quebec (CA); Yannick Koehler, Quebec (CA)

(21) Appl. No.: 15/027,690

(22) PCT Filed: Oct. 16, 2013
(86) PCT No.: PCT/US2013/065217

§ 371 Date: Apr. 6, 2016

(51) Int. Cl. H04L 12/18; H04L 12/66; H04L 29/12; H04L 29/06

(52) U.S. Cl. CPC H04L 12/18; H04L 63/0209; H04L 63/0227; H04L 63/10; H04L 12/66; H04L 61/1511

(57) ABSTRACT

Receiving mDNS packets can include a network, which can include an access controller, an mDNS gateway, and a number of network interfaces configured to reflect a multicast Domain Name Service (mDNS) packet.

### BACKGROUND

A computer network or data network is a telecommunications network that allows computers to exchange data. In computer networks, networked computing devices can pass data to each other along data connections. The connections (e.g., network links) between computing devices can be established using cable media and/or wireless media. Computer networks can support applications such as access to the World Wide Web, shared use of application and storage servers, printers, and fax machines, and use of email and instant messaging applications.

### BRIEF DESCRIPTION OF THE DRAWINGS

FIG. 1 is a diagram illustrating an example of a network according to the present disclosure.

FIGS. 2A-2B are diagrams illustrating an example dataflow according to the present disclosure.

FIG. 3A is a diagram illustrating an example of a system according to the present disclosure.

FIG. 3B is a diagram illustrating an example of a network controller according to the present disclosure.

FIG. 4 is a flow chart illustrating an example of a method according to the present disclosure.

FIG. 5 is a flow chart further illustrating examples of methods according to the present disclosure.

### DETAILED DESCRIPTION

Certain network systems can be used to create a network of devices without having to manually configure each device connected to the network. Some mDNS networks can discover (e.g., identify) network devices such as printers, other computers, and/or the services that those devices offer, on a local area network using multicast Domain Name System (mDNS) packets. A network using mDNS packets is referred to herein as an mDNS network. As used herein, mDNS includes a distributed naming system for computers, services, and/or resources connected to a network that does not require a managed Domain Name System (DNS) server. Using mDNS, domain names can be translated into numerical internet protocol (IP) addresses for locating computer services and/or devices. As used herein, a packet includes a unit of binary data capable of being routed through a computer network. A packet can include a header, a body containing message data, e.g., the payload, and can include a footer, e.g., a trailer.

Standard mDNS networks include link-local protocols, e.g., IP protocols that are intended for communications within a segment of a local network, in which mDNS packets cannot be routed between networks. However, some mDNS networks can include an mDNS gateway, e.g., hardware, logic and/or instructions executable by processing resources to manage and/or control an mDNS system, which allows mDNS packets to cross network boundaries. For instance, mDNS packets from one network can be reflected, e.g., retransmitted and/or shared, on other networks using an mDNS gateway. However, in such networks, mDNS packets can be reflected, unrestricted, to all networks connected to the mDNS gateway.

In contrast, in accordance with examples of the present disclosure, an mDNS traffic handling system can enable mDNS packet routing between networks while implementing access control policies. As used herein, an access control policy includes a number of defined rules that restrict access to portions of an mDNS network. Rules that restrict access to portions of the mDNS network can include business defined policies, anti-virus protection policies, and/or system update level policies. By enabling mDNS packet routing while implementing access control policies, mDNS packets can be reflected on networks satisfying the access control policies, thereby improving mDNS network security.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

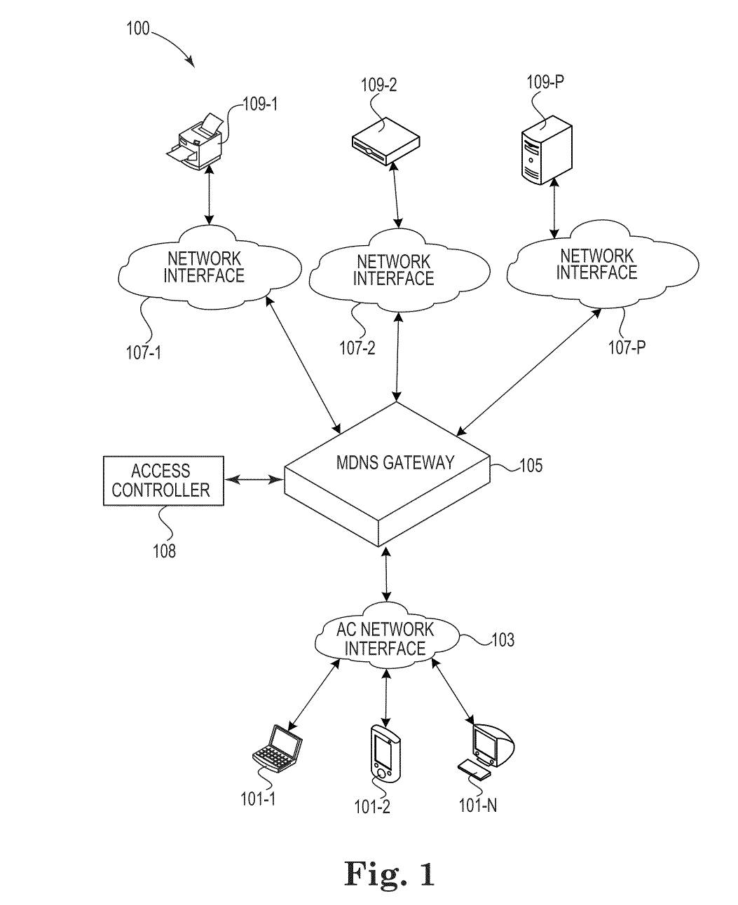

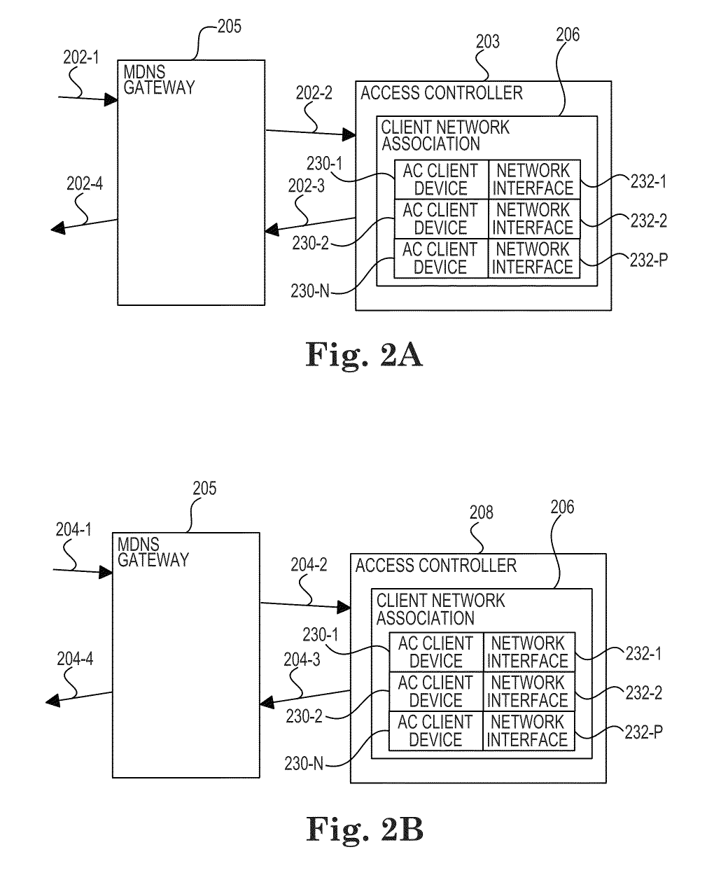

The figures herein follow a numbering convention in which the first digit corresponds to the drawing figure number and the remaining digits identify an element or component in the drawing. For example, reference numeral 105 may refer to element “5” in FIG. 1 and an analogous element may be identified by reference numeral 205 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. As used herein, the designators “N” and “P”, particularly with respect to reference numerals in the drawings, indicate that a number of the particular feature and/or component so designated can be included with a number of examples of the present disclosure. The designators “N” and “P” can refer to a same feature and/or component, or different features and/or components.

FIG. 1 is a diagram illustrating an example of a network 100 according to the present disclosure. In some examples, the network 100 can include a local area network (LAN), a wide area network (WAN), and/or a personal area network (PAN), among others. The network 100 can include an mDNS network. The network 100 can include a number of access controlled (AC) client devices, e.g., AC client devices 101-1, 101-2, 101-N, herein referred to as AC client devices 101. An AC client device can include a device that is managed by an access control network interface (AC network interface) 103. Examples of AC client devices can include laptop computers, desktop computers, printers, tablet computers, and/or personal digital assistants (PDAs), among other devices. As used herein, an AC network interface 103 includes an interface that receives mDNS packets from an AC client device and determines which AC client device has sent the mDNS packet. AC network interface 103 can be connected to an mDNS gateway, e.g., mDNS gateway 105. As previously discussed, mDNS gateway 105 can include hardware and/or instructions executable to manage and/or control an mDNS network.

In a number of examples, network 100 can include a number of network interfaces, e.g., network interfaces 107-1, 701-2, 107-P, herein referred to as network interfaces 107. As used herein, a network interface can include a point of interconnection between a computing device and a public and/or private network. Each of the number of network interfaces 107 can be associated with a number of network devices, e.g., network devices 109-1, 109-2, 109-P, herein referred to as network devices 109. For example, network interface 107-1 can be associated with a printer, e.g., network device 109-1, server, laptop, wireless device, workstation, and/or a desktop computer, among other devices. Similarly, each of the number of network interfaces 107 can be associated with a number of services provided by associated network devices 109. For instance, network interface 107-1 can be associated with a number of printing services, e.g., remote print, scan and/or fax, among other services, provided by network device 109-1.

Network interfaces 107 can be configured for reflection with the mDNS gateway 105. Configuring a network interface for reflection can include registering the network interface with the mDNS gateway 105 so that mDNS packets sent from AC client devices 101 can be received by the configured network interface. Reflection, as used herein, can include discovery of a number of network interfaces within a network, using mDNS packets. For instance, in response to receiving an mDNS packet of the form “where is Bob.local?” from AC client device 101, a network interface, e.g., network interface 107-1, can respond with an IP address assigned to a network device, e.g., network device 109-1, within the particular network interface 107-1, assuming that network device 109-1 is named Bob.

In a number of examples, the number of AC client devices 101 can have an egress interface configured with an access controller 108. As discussed further herein, an access controller 108 can include hardware and/or programming to implement access control policies to limit access of AC client devices to an mDNS network and/or portions of an mDNS network. As used herein, an egress interface can include a network interface other than the AC network interface 103, on which traffic, e.g., packets, from an AC client device can be routed. For example, network interface 107-1 and network interface 107-2 can be configured for reflection, e.g., discovery, in the mDNS gateway 105. Similarly AC client devices 101-1, 101-2, and 101-N can have egress interfaces configured such that packets from AC client device 101-1 can be routed to network interface 107-1, and packets from AC client device 101-2 can be routed to network interface 107-2. In this example, by incorporating egress interface configurations, AC client device 101-1 can only discover network device 109-1, AC client device 101-2 can only discover network device 109-2, and AC client device 101-N cannot discover any network device, because network interface 107-P was not configured for reflection.

FIGS. 2A-2B are diagrams illustrating an example dataflow according to the present disclosure. FIG. 2A illustrates an example dataflow from AC client devices to network interfaces. At 202-1, the mDNS gateway 205 can receive an mDNS packet from an AC client device. In response to receiving an mDNS packet from the AC client device, the mDNS gateway 205 can send a network request to an access controller 208 at 202-2. A network request can include a request, e.g., query, to access the mDNS network, e.g., network 100, referenced in FIG. 1, and/or a portion of the mDNS network. An access controller can include hardware and/or programming to implement access control policies to limit access of AC client devices to an mDNS network and/or portions of an mDNS network. In response to receiving a network request, the access controller 208 can determine if each of the number of egress interfaces in the mDNS network is configured for reflection.

In a number of examples, whether an egress interface is configured for reflection can be stored in a client network association table 206. A client network association table 206 can include a number of entries, wherein an entry associated with a device, e.g., AC client device entries 230-1, 230-2, 230-N, can be correlated to an entry associated with a particular network interface, e.g., network interface entries 232-1, 232-2, 232-P. The client network association table 206 can specify which network interfaces, e.g., network interfaces 107 illustrated in FIG. 1, are configured for reflection within the mDNS network, and/or can specify a particular network interface, e.g., 107-1, on which packets from a particular AC client device, e.g., 101-1, can be received. For instance, client network association table 206 can include an entry for AC client device 101-1, e.g., AC client device entry 230-1, and can be correlated to an entry for network interface 107-1, e.g., network interface entry 232-1, wherein network interface 107-1 is configured for AC client device 101-1. In a number of examples of the present disclosure, instructions associated with the access controller 208 are executed to populate the client network association table 206 when an AC client device associates with, e.g., connects to, the mDNS network, e.g., network 100, referenced in FIG. 1. In some examples, the client network association table 206 can be updated when an AC client device provides authentication to access the mDNS network.

At 202-3, in response to determining which of the number of egress interfaces in the mDNS network is configured for reflection, the access controller 208 can send a network response to the mDNS gateway 205. A network response can include a response, e.g., answer, to the network request presented at 202-2, and can specify for the mDNS gateway 205, which, if any, of the network interfaces 207 can reflect an mDNS packet from the AC client device. At 202-4, in response to receiving a network response from the access controller 208, the mDNS gateway 205 can send the mDNS packet to one or more particular network interfaces, e.g., network interfaces 107 illustrated in FIG. 1, identified for reflection in the network response 202-3 sent to the mDNS gateway 205.

FIG. 2B illustrates an example dataflow from network interfaces to AC client devices. At 204-1, an mDNS packet can be received from a network interface. As previously discussed, an mDNS packet refers to a multicast Domain Name Service packet. An mDNS packet can include a DNS packet that is delivered to a number of devices substantially simultaneously in a single transmission. At 204-2, in response to receiving an mDNS packet from a network interface, the mDNS gateway 205 can send an AC client device request to the access controller 208. An AC client device request can include a request to send a unicast DNS packet to an AC client device. As illustrated in FIG. 2B, the access controller 208 can determine which, if any, AC client device can send and/or receive packets from the network interface using the client network association table 206. At 204-3, the access controller 208 can respond to the mDNS gateway 205 with a response identifying a number of AC client devices that can send and/or receive packets from the network interface which sent the mDNS packet. At 204-4, in response to receiving the response at 204-3, the mDNS gateway 205 can send a number of unicast DNS packets to each of the AC client devices identified by the access controller 208. As used herein, a unicast DNS packet can include a DNS packet that is sent to a single destination, e.g., a single AC client device, and/or a single network interface, identified by a unique address. Although FIG. 2B illustrates a single unicast DNS packet being sent, the present disclosure is not limited to the sending of a single unicast DNS packet, and multiple unicast DNS packets can be returned as responses to different AC client devices, e.g., AC client devices 101 illustrated in FIG. 1.

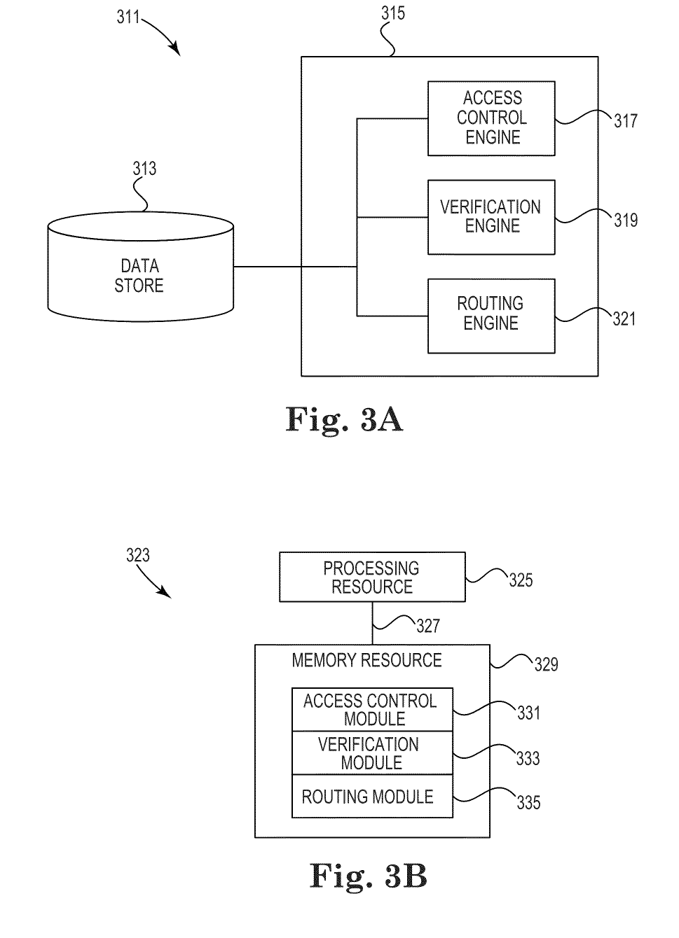

FIG. 3A is a diagram illustrating an example of a system 311 according to the present disclosure. The system 311 can include a data store 313, a subsystem 315, and/or a number of engines 317, 319, 321. The subsystem can include the number of engines, e.g., access control engine 317, verification engine 319, and/or routing engine 321, and can be in communication with the data store 313 via a communication link. The system 311 can include additional or fewer engines than illustrated to perform the various functions described herein. The system can include software and/or hardware of a network controller, e.g., network controller 323 as referenced in FIG. 3B, etc. A network controller can be part of an access controller, e.g., access controller 208 illustrated in FIG. 2.

The number of engines can include a combination of hardware and programming, but includes at least hardware used to perform a number of functions described herein, e.g., to determine, using the client network association table, if a network interface is configured for an AC client device, etc. The programming can include program instructions, e.g., software, firmware, etc., stored in a memory resource, e.g., computer readable medium, machine readable medium, etc., as well as application specific integrated circuits (ASICs), e.g., logic.

Each of the number of engines 317, 319, 321 can function as a corresponding module as described with respect to FIG. 3B. For example, the access control engine 317 can include hardware and/or a combination of hardware and programming to perform as the access control module 331, described in more detail below. In another example, the verification engine 319 can include hardware and/or a combination of hardware and programming that can function as the verification module 333. Further, the routing engine can include hardware and/or a combination of hardware and programming that can function as the routing module.

FIG. 3B is a diagram illustrating an example of a network controller 323 according to the present disclosure. For example, the network controller 323 can be implemented in the mDNS gateway, e.g., 105 illustrated in FIG. 1 and/or 205 illustrated in FIG. 2. The network controller 323 can utilize software, hardware, firmware, and/or logic to perform a number of functions.

The network controller 323 can be a combination of hardware and program instructions configured to perform a number of functions (e.g., actions). The hardware, for example, can include a number of processing resources 325 and a number of memory resources 329, such as a machine-readable medium (MRM) or other memory resources 329. The memory resources 329 can be internal and/or external to the network controller 323 (e.g., the network controller 323 can include internal memory resources and have access to external memory resources). The program instructions (e.g., machine-readable instructions (MRI)) can include instructions stored on the MRM to implement a particular function (e.g., an action such as routing an mDNS packet to a network interface based on a configuration). The instructions can be executable by one or more of the processing resources 325. The memory resources 329 can be coupled to the network controller 323 in a wired and/or wireless manner. For example, the memory resources 329 can be an internal memory, a portable memory, a portable disk, and/or a memory associated with another resource, e.g., enabling instructions to be transferred and/or executed across a network such as the Internet.

Memory resources 329 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of machine-readable media.

The processing resources 325 can be coupled to the memory resources 329 via a communication path 327. The communication path 327 can be local or remote to the network controller 323. Examples of a local communication path 327 can include an electronic bus internal to a machine, where the memory resources 329 are in communication with the processing resources 325 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 327 can be such that the memory resources 329 are remote from the processing resources 325, such as in a network connection between the memory resources 329 and the processing resources 325. That is, the communication path 327 can be a network connection. Examples of such a network connection can include LAN, wide area network (WAN), PAN, and the Internet, among others.

As shown in FIG. 3B, the MRI stored in the memory resources 329 can be segmented into a number of modules 331, 333, 335 that when executed by the processing resources 325 can perform particular functions. As used herein a module includes a set of instructions included to perform a particular task or action. The number of modules 331, 333, 335 can be sub-modules of other modules. For example, the access control module 331 can be a sub-module of the verification module 333 and/or the access control module 331 and the verification module 333 can be contained within a single module. Furthermore, the number of modules 331, 333, 335 can comprise individual modules separate and distinct from one another. Examples are not limited to the specific modules 331, 333, 335 illustrated in FIG. 3B.

The network controller 323 can include an access control module 331, which can store a client network association table, e.g., client network association table 206 illustrated in FIG. 2, wherein the client network association table includes a list of a number of AC client devices and a list of a number of network interfaces configured for reflection in an mDNS network. In a number of examples, the access control module 331 can populate the client network association table when an AC client device associates with the mDNS network. Similarly, the access control module 331 can update and/or revise the client network association table when a client, e.g., a user, provides authentication, e.g., password and/or username among other forms of authentication, to access the mDNS network.

The network controller 323 can include a verification module 333, which can verify, e.g., determine, using the client network association table, if a network interface among the number of network interfaces is specified for an AC client device among the number of AC client devices. In some examples, an mDNS packet can be received from a client device other than an AC client device. In such examples, the verification module 333 can verify if an egress interface is specified for the client device.

The network controller 323 can include a routing module 321 to route data to the network interface based on the specification, using the mDNS gateway. For example, in response to identifying that a specific egress interface is not specified for a particular AC client device, an mDNS packet can be sent to all network interfaces configured for reflection in the mDNS network. In another example, in response to identifying that a number of egress interfaces are specified for a particular AC client device, the mDNS packet from the particular AC client device can be sent to the number of egress interfaces specified.

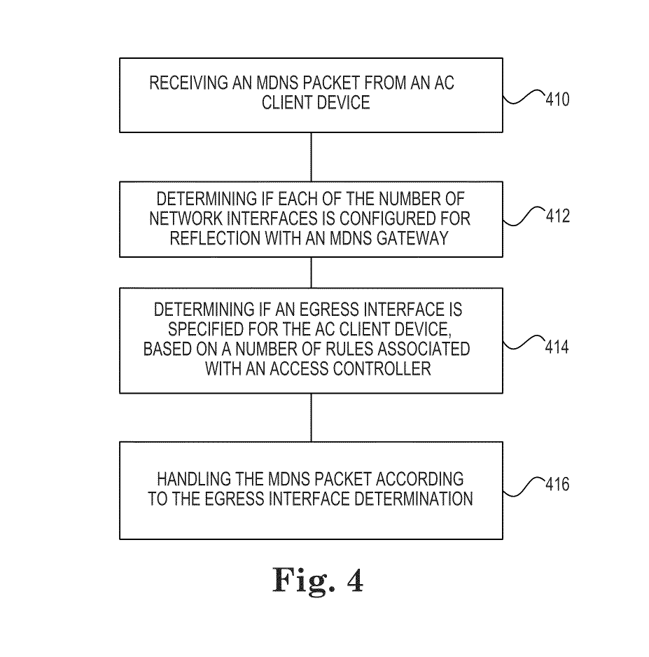

FIG. 4 is a flow chart illustrating an example of a method according to the present disclosure. At block 410, the method can include receiving an mDNS packet from an AC client device. At block 412, the method can include determining which of a number of network interfaces connected to a particular network, is configured for reflection with an mDNS gateway. At block 414, the method can include determining if an egress interface is specified for the sending AC client device, based on a number of rules associated with an access controller. At block 416, the method can include handling the mDNS packet according to the determination. By handling mDNS packets according to determinations made by an access controller, users are not able to access network devices and/or the services provided by those network devices unless they have authorization to access them. Similarly, handling mDNS packets according to determinations made by an access controller can improve security of the mDNS network by not exposing the topology of the mDNS network to users who do not have the necessary authorization to see it.

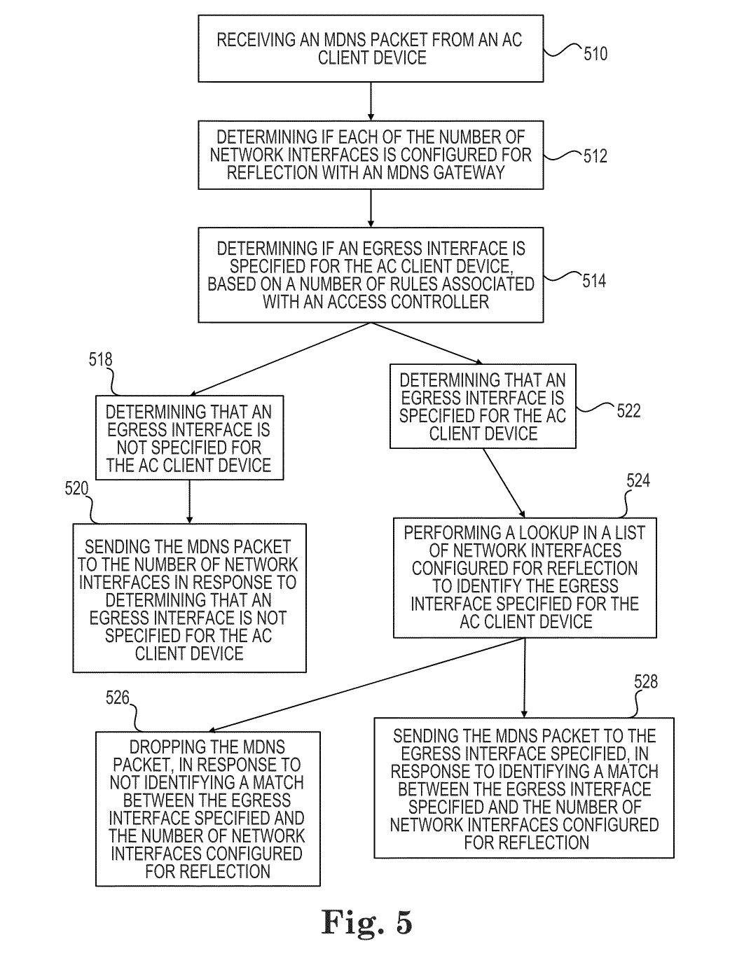

FIG. 5 is a flow chart further illustrating examples of methods according to the present disclosure. At block 510, the method can include receiving an mDNS packet from an AC client device. At block 512, the method can include determining if each of the number of network interfaces is configured for reflection with an mDNS gateway. At block 514, the method can include determining if an egress interface is specified for the AC client device, based on a number of rules associated with an access control system, e.g., using a verification engine and/or a verification module illustrated in FIGS. 3A and 3B. At block 518, the method can include determining that an egress interface is not specified for the AC client device. At block 520, the method can include sending the mDNS packet to the number of network interfaces in response to determining that an egress interface is not specified for the AC client device, e.g., using a routing engine and/or routing module illustrated in FIGS. 3A and 3B.

At 522, the method can include determining that an egress interface is specified for the AC client device. At 524, the method can include performing a lookup in a list of network interfaces configured for reflection to identify the egress interface specified for the AC client device. For example, the method can include performing a lookup in the client network association table, to determine if a particular egress interface is specified for the particular AC client device which sent the mDNS packet, e.g., using a verification engine and/or a verification module illustrated in FIGS. 3A and 3B. At 526, the method can include dropping the mDNS packet, in response to not identifying a match between the egress interface specified and the number of network interfaces configured for reflection. For instance, if the mDNS gateway 105, illustrated in FIG. 1, determines that the specific interface specified for the particular AC client device is not configured for reflection, then the mDNS packet will be dropped and will not be reflected to any of the network interfaces. At 528, the method can include sending the mDNS packet to the egress interface specified, in response to identifying a match between the egress interface specified and the number of network interfaces configured for reflection, e.g., using the routing engine and/or the routing module illustrated in FIGS. 3A and 3B. In a number of examples, the mDNS packet can be sent to a number of egress interfaces.

In a number of examples (not illustrated), the method can include receiving an mDNS packet from a client device other than an AC client device, and which must be reflected to an AC client device. The method can include determining if an egress interface is specified for the client device, and reflecting the mDNS packet to the AC client device in response to determining that an egress interface is not specified for the client device. Similarly, if an egress interface is specified for the client device, the method can include comparing the specified egress interface with the interface for the AC client device to which the mDNS packet is to be sent. If the specified egress interface matches the interface for the AC client device, e.g., they are the same interface, then the method can include reflecting the mDNS packet to the AC client device. Similarly, if the specified egress interface does not match the interface for the AC client device, then the method can include dropping, e.g., not reflecting, the mDNS packet.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed is:

1. A network, including:
an access controller;
a mDNS gateway connected to the access controller; and
a number of network interfaces connected to the mDNS gateway and configured to receive a multicast Domain Name Service (mDNS) packet based on configurations stored in the access controller.

2. The network of claim 1, further including a number of access controlled (AC) client devices, wherein the number of AC client devices are devices that are managed by an access control network interface.

3. The network of claim 2, wherein the mDNS gateway determines if the mDNS packet is received from an AC client device among the number of AC client devices.

4. The network of claim 1, wherein the configurations stored in the access controller specify a network interface among the number of network interfaces on which the mDNS packet can be reflected.

5. The network of claim 1, wherein the mDNS gateway is configured to convert the mDNS packet to a number of unicast DNS packets.

6. A system, comprising:
an access control engine to store a client network association table, wherein the client network association table includes a list of a number of AC client devices and a list of a number of network interfaces configured for reflection by a mDNS gateway;
a verification engine to verify, using the client network association table, if a network interface among the number of network interfaces is specified for an AC client device among the number of AC client devices; and
a routing engine to route data to the network interface based on the specification, using the mDNS gateway.

7. The system of claim 6, wherein the network interface is specified for the AC client device when the client associates with the gateway.

8. The system of claim 6, wherein the network interface is specified for the AC client device when the client provides authentication to the mDNS gateway.

9. The system of claim 6, wherein reflection includes the network interface responding to receipt of a multicast DNS packet with an IP address assigned to a network device associated with the network interface.

10. A method, including:
receiving an mDNS packet from an access controlled (AC) client device;
determining if each of a number of network interfaces is configured for reflection with an mDNS gateway;
determining if an egress interface is specified for the AC client device, based on a number of rules associated with an access controller; and
handling the mDNS packet according to the egress interface determination.

11. The method of claim 10, further including:
determining that each of the number of network interfaces is configured for reflection with the mDNS gateway; and
sending the mDNS packet to the number of network interfaces in response to determining that an egress interface is not specified for the AC client device.

12. The method of claim 10, further including:
determining that an egress interface is specified for the AC client device; and
performing a lookup in a list of network interfaces configured for reflection to identify the egress interface specified for the AC client device.

13. The method of claim 12, further including:
sending the mDNS packet to the egress interface specified, in response to identifying a match between the egress interface specified and the number of network interfaces configured for reflection.

14. The method of claim 12, further including:
dropping the mDNS packet in response to not identifying a match between the egress interface specified and the number of network interfaces configured for reflection.

15. The method of claim 10, wherein the number of rules restrict access to portions of the network and include a number of anti-virus protection policies.
